(19) United States
(12) Patent Application Publication
(10) Pub. No.: US 2023/0145435 A1
(43) Pub. Date: May 11, 2023

(54) ELECTRONIC DEVICE AND PROGRAM

(71) Applicant: KYOCERA Document Solutions Inc., Osaka (JP)

(72) Inventor: Minoru TAKAHASHI, Osaka-shi (JP)

(21) Appl. No.: 17/905,635

(22) PCT Filed: Mar. 2, 2021
(86) PCT No.: PCT/JP2021/007956

§ 371 Date: Sep. 4, 2022

(30) Foreign Application Priority Data
Mar. 6, 2020 (JP) 2020-038595

(51) Int. Cl. H04N 1/00

(52) U.S. Cl. CPC H04N 1/0097; H04N 1/00938

(57) ABSTRACT

An electronic device and a program that can facilitate expansion of a data collection function are provided. An image forming apparatus includes a data collection service that provides a service related to a data collection function, and a data collection application that uses the data collection service. The data collection application sets, in the data collection service, an acquisition timing, which is a parameter related to the data collection function, and a data item. The data collection service performs specific processing in the data collection function according to the parameter set by the data collection application (S401 to S403).

### TECHNICAL FIELD

The present invention relates to an electronic device and a program that can collect data.

### BACKGROUND ART

As a conventional electronic device, there is known an image forming apparatus including a standard application, which is an application that achieves a standard function of the image forming apparatus, an expansion application, which is an application that achieves a function other than the standard function of the image forming apparatus, and an expansion function service that provides the expansion application with a function of expanding the standard function of the image forming apparatus without using the standard application (see Patent Literature 1).

### CITATION LIST

### Patent Literature

PTL 1: International Publication No. WO2015/182303

### SUMMARY OF THE INVENTION

### Problems to be Solved by the Invention

However, in the conventional image forming apparatus, there is a problem that no consideration is given to expanding a data collection function.

In view of the above, an object of the present invention is to provide an electronic device and a program that can facilitate expansion of a data collection function.

### Means for Solving the Problem

An electronic device according to the present invention includes: a data collection service that provides a service related to a function of collecting data; and a service use unit that uses the data collection service. The service use unit sets a parameter related to the function in the data collection service. The data collection service performs specific processing in the function according to the parameter set by the service use unit.

This configuration allows the electronic device according to the present invention to set the parameter related to the data collection function in the data collection service by the service use unit, and perform specific processing in the data collection function by the data collection service according to the parameter set by the service use unit. Therefore, it is possible to expand the data collection function without updating the data collection service, and consequently, expansion of the data collection function can be facilitated.

An electronic device according to the present invention includes: a data collection service that provides a service related to a function of collecting data; and a service use unit that uses the data collection service. The service use unit performs specific processing in the function in response to a notification from the data collection service.

This configuration allows the electronic device according to the present invention to perform specific processing in the data collection function by the service use unit in response to a notification from the data collection service. Therefore, it is possible to expand the data collection function without updating the data collection service, and consequently, expansion of the data collection function can be facilitated.

In the electronic device according to the present invention, preferably, the data collection service may be achieved by a firmware of the electronic device, and the service use unit may be achieved by a program other than the firmware.

This configuration allows the electronic device according to the present invention to achieve the data collection service by the firmware of the electronic device, and achieve the service use unit by a program other than the firmware. Therefore, it is possible to expand the data collection function without updating the firmware, and consequently, expansion of the data collection function can be facilitated.

In the electronic device according to the present invention, preferably, the specific processing may include conversion of the data.

This configuration allows the electronic device according to the present invention to perform expansion for conversion of collected data.

In the electronic device according to the present invention, preferably, the specific processing may include outputting the data to an outside of the electronic device.

This configuration allows the electronic device to perform expansion for output of data to the outside of the electronic device.

A program according to the present invention causes an electronic device to achieve: a data collection service that provides a service related to a function of collecting data; and a service use unit that uses the data collection service. The service use unit sets a parameter related to the function in the data collection service. The data collection service performs specific processing in the function according to the parameter set by the service use unit.

This configuration allows the electronic device executing the program according to the present invention to set a parameter related to the data collection function in the data collection service by the service use unit, and perform specific processing in the data collection function by the data collection service according to the parameter set by the service use unit. Therefore, it is possible to expand the data collection function without updating the data collection service, and consequently, expansion of the data collection function can be facilitated.

A program according to the present invention causes an electronic device to achieve: a data collection service that provides a service related to a function of collecting data; and a service use unit that uses the data collection service. The service use unit performs specific processing in the function in response to a notification from the data collection service.

This configuration allows the electronic device executing the program according to the present invention to perform specific processing in the data collection function by the service use unit in response to a notification from the data collection service. Therefore, it is possible to expand the data collection function without updating the data collection service, and consequently, expansion of the data collection function can be facilitated.

### Effect of the Invention

An electronic device and a program according to the present invention can facilitate expansion of a data collection function.

### BRIEF DESCRIPTION OF THE DRAWINGS

FIG. 1 is a block diagram of a hardware of an image forming apparatus according to an embodiment of the present invention.

FIG. 2 is a block diagram of a control configuration of the image forming apparatus illustrated in FIG. 1.

FIG. 3 is a diagram illustrating a data collection application, which is an expansion application illustrated in FIG. 2.

FIG. 4 is a diagram illustrating a model of a flow of processing when a data collection function is achieved by the image forming apparatus illustrated in FIG. 1.

FIG. 5 is a diagram illustrating an expandable point in data collection processing by the image forming apparatus illustrated in FIG. 1.

FIG. 6(a) is a diagram illustrating an example of a standard specification of the data collection function illustrated in FIG. 4. FIG. 6(b) is a diagram illustrating an example of an expanded specification of the data collection function illustrated in FIG. 4.

FIG. 7 is a flowchart of an operation of the image forming apparatus illustrated in FIG. 1 in a case where an acquisition step and a primary accumulation step are performed.

FIG. 8 is a sequence diagram of an operation of the image forming apparatus illustrated in FIG. 1 in a case where a conversion step and a secondary accumulation step are performed.

FIG. 9 is a sequence diagram of an operation of the image forming apparatus illustrated in FIG. 1 in a case where an output step is performed.

FIG. 10 is a flowchart of an operation of the image forming apparatus illustrated in FIG. 1 when a data collection condition is updated during execution of data collection processing.

FIG. 11 is a flowchart of an operation of the image forming apparatus illustrated in FIG. 1, which is different from the example illustrated in FIG. 10, when the data collection condition is updated during execution of data collection processing.

FIG. 12 is a sequence diagram of an operation of the image forming apparatus illustrated in FIG. 1 in a case where internal processing data are deleted from an internal processing area.

FIG. 13 is a sequence diagram of an operation of the image forming apparatus illustrated in FIG. 1 in a case where external output data are deleted from an external output area.

FIG. 14 is a sequence diagram of an operation of the image forming apparatus illustrated in FIG. 1 in a case where an error related to data collection processing has occurred.

### MODE FOR CARRYING OUT THE INVENTION

In the following, an embodiment according to the present invention is described with reference to the drawings.

First, a configuration of an image forming apparatus as an electronic device according to an embodiment of the present invention is described.

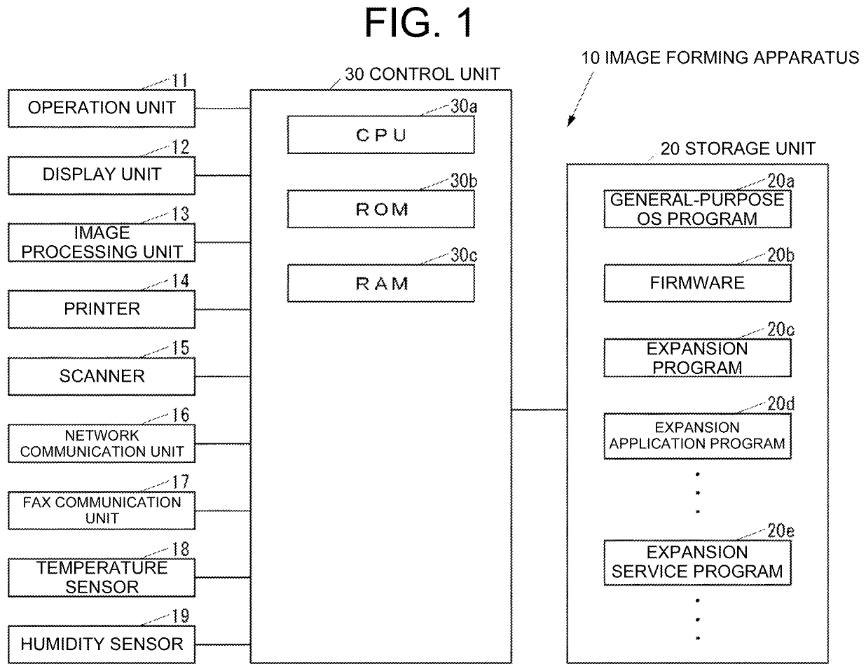

FIG. 1 is a block diagram of a hardware of an image forming apparatus 10 according to the present embodiment.

As illustrated in FIG. 1, the image forming apparatus 10 is a multifunction peripheral (MFP) including: an operation unit 11, which is an operation device such as, for example, a button through which various operations are input; a display unit 12, which is a display device such as, for example, a liquid crystal display (LCD) that displays various pieces of information; an image processing unit 13, which is an image processing device such as, for example, a graphics processing unit (GPU) that performs various types of image processing with respect to image data, such as, for example, enlargement, reduction, density adjustment, gradation adjustment, and image improvement; a printer 14, which is a printing device that prints an image on a recording medium such as paper; a scanner 15, which is a reading device that reads an image from a document; a network communication unit 16, which is a communication device that performs communication with an external device via a network such as a local area network (LAN), the Internet, or the like, or directly via wired or wireless connection without intervening a network; a fax communication unit 17, which is a fax device that performs fax communication with an unillustrated external facsimile device via a communication line such as a public telephone line; a temperature sensor 18 that detects an internal temperature (hereinafter, referred to as an “apparatus internal temperature”) of the image forming apparatus 10; a humidity sensor 19 that detects an internal humidity (hereinafter, referred to as an “apparatus internal humidity”) of the image forming apparatus 10; a storage unit 20, which is a non-volatile storage device such as, for example, a semiconductor memory or a hard disk drive (HDD) that stores various pieces of information; and a control unit 30 that controls the entirety of the image forming apparatus 10.

The storage unit 20 stores a program (hereinafter, referred to as a “general-purpose OS program”) 20a for a general-purpose operating system (OS) such as, for example, Linux (registered trademark) for controlling each hardware of the image forming apparatus 10.

The storage unit 20 stores a firmware 20b of the image forming apparatus 10.

The storage unit 20 stores an expansion program 20c, which is a program for achieving a function other than a standard function of the image forming apparatus 10.

The storage unit 20 stores a program (hereinafter, referred to as an “expansion application program”) 20d for an expansion application, which is an application that achieves a function other than a standard function of the image forming apparatus 10. The storage unit 20 can store an expansion application program for each expansion application.

The storage unit 20 stores a program (hereinafter, referred to as an “expansion service program”) 20e for an expansion service that provides an expansion application with a service in which a general-purpose OS is used without using a standard application, which is an application that achieves a standard function of the image forming apparatus 10. The storage unit 20 can store an expansion service program for each expansion service.

The control unit 30 includes, for example, a central processing unit (CPU) 30a, a read only memory (ROM) 30b that stores a program and various pieces of data, a random access memory (RAM) 30c as a memory used as a work area of the CPU 30a. The CPU 30a executes a program stored in the storage unit 20 or the ROM 30b.

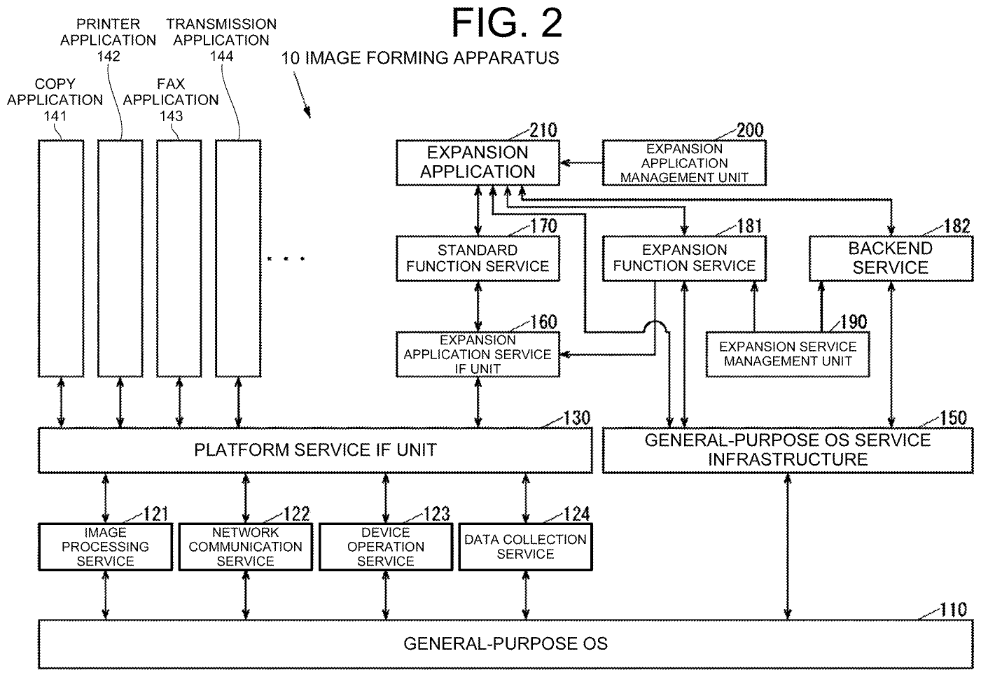

The control unit 30 achieves a control configuration illustrated in FIG. 2 by executing a program stored in the storage unit 20 or the ROM 30b.

FIG. 2 is a block diagram of a control configuration of the image forming apparatus 10.

As illustrated in FIG. 2, the control unit 30 achieves a general-purpose OS 110 by executing the general-purpose OS program 20a (see FIG. 1).

The control unit 30 achieves, by executing the firmware 20b (see FIG. 1), an image processing service 121 that runs on the general-purpose OS 110 and provides a service related to image processing, a network communication service 122 that runs on the general-purpose OS 110 and provides a service related to communication via a network, a device operation service 123 that runs on the general-purpose OS 110 and provides a service that operates each hardware of the image forming apparatus 10, and a data collection service 124 that runs on the general-purpose OS 110 and provides a service related to a function of collecting data (hereinafter, referred to as a “data collection function”). Each of the image processing service 121, the network communication service 122, and the device operation service 123 controls each hardware of the image forming apparatus 10 via the general-purpose OS 110.

The image processing service 121 may provide, for example, a service that causes the storage unit 20 to store image data read from a document by setting a resolution, a color, and other parameters by means of the scanner 15, and causes the image processing unit 13 to perform image processing with respect to image data stored in the storage unit 20. The image processing service 121 may provide a service that draws image data to be printed by the printer 14, based on a file. The image processing service 121 may provide a service that performs image processing such as enlargement, reduction, rotation, color conversion, noise removal, format conversion, character recognition, and watermark recognition with respect to image data acquired from an expansion application, image data read from a document by the scanner 15, or image data stored in the storage unit 20.

The network communication service 122 may provide a service that performs file transmission and reception, streaming, and transmission and reception of authentication data via the network communication unit 16 by using various protocols such as TCP/IP and UDP. For example, the network communication service 122 can also transmit and receive image data read from a document by the scanner 15, and a file stored in the storage unit 20. Note that, in a case where the image forming apparatus 10 includes a user authentication unit that authenticates a user by means of transmission and reception of image data that have been transmitted and received by the fax communication unit 17, an IC card, or biometrics, the network communication service 122 can also transmit and receive a result of user authentication by the user authentication unit; and in a case where the image forming apparatus 10 includes a camera, the network communication service 122 can also transmit and receive video data generated by the camera. Further, the network communication service 122 can also transmit and receive a status of each unit of the image forming apparatus 10, a result of invocation of a function of each unit, and the like.

The device operation service 123 may provide a service that performs processing such as drawing on the display unit 12, driving the printer 14, controlling the fax communication unit 17, user authentication, and acquisition of a status of each hardware of the image forming apparatus 10. The device operation service 123 may, for example, provide a service that stores, in the storage unit 20, image data read from a document by the scanner 15, provide a service that draws an image on a browser to be displayed on the display unit 12, provide a service that transmits image data to the printer 14 for image formation, or provide a service that causes the fax communication unit 17 to transmit image data stored in the storage unit 20. In a case where the image forming apparatus 10 includes an optional device such as, for example, a finisher, the device operation service 123 may cause the optional device to perform processing such as, for example, binding or stapling; in a case where the image forming apparatus 10 includes a user authentication unit that authenticates a user by an IC card or biometrics, the device operation service 123 may provide a service that causes the user authentication unit to perform user authentication; and in a case where the image forming apparatus 10 includes a camera, the device operation service 123 may provide a service that causes the camera to generate video data, or invoke each function such as line-of-sight detection based on video data generated by the camera. The device operation service 123 may provide a service that performs detailed control of each hardware of the image forming apparatus 10 such as, for example, driving one of motors of a transport unit of the printer 14. The device operation service 123 may provide a service that acquires a status of each unit of the image forming apparatus 10.

The control unit 30 achieves, by executing the firmware 20b, a platform service IF unit 130 that provides an interface for invoking the image processing service 121, the network communication service 122, and the device operation service 123.

The control unit 30 achieves a standard application by executing the firmware 20b. The standard application runs on the platform service IF unit 130, and implements each hardware of the image forming apparatus 10. For example, the control unit 30 achieves a copy application 141, which is a standard application that reads an image from a document by the scanner 15 in response to an instruction input to the operation unit 11, and achieves printing/copying the read image by the printer 14; a printer application 142, which is a standard application that prints an image based on data received by the network communication unit 16 such as, for example, data written in a page description language (PDL) by means of the printer 14; a fax application 143, which is a standard application that reads an image from a document by the scanner 15 in response to an instruction input to the operation unit 11, and transmits the read image by means of the fax communication unit 17; and a transmission application 144, which is a standard application that reads an image from a document by the scanner 15 in response to an instruction input to the operation unit 11, and transmits the read image by means of the network communication unit 16. The printer application 142 may print an image based on a file stored in the storage unit 20 by means of the printer 14 in response to an instruction input to the operation unit 11. The fax application 143 may transmit an image based on a file received by the network communication unit 16 by means of the fax communication unit 17, print an image received by the fax communication unit 17 by means of the printer 14, or store an image received by the fax communication unit 17 in the storage unit 20.

The control unit 30 achieves, by executing the expansion program 20c (see FIG. 1), a general-purpose OS service infrastructure 150 that provides a service in which the general-purpose OS 110 is used without intervening the platform service IF unit 130. The general-purpose OS service infrastructure 150 may provide a service that adds a function to the general-purpose OS 110, such as installing a control program such as a device driver and a script on the general-purpose OS 110.

The control unit 30 achieves, by executing the expansion program 20c, an expansion application service IF unit 160 that provides an interface for using the platform service IF unit 130 from the expansion application side.

The control unit 30 achieves, by executing the expansion program 20c, a standard function service 170, which is a service that provides an expansion application with a standard function of the image forming apparatus 10 by using a standard application. The standard function service 170 uses a standard application via the expansion application service IF unit 160. For example, the expansion application can display, on the display unit 12, a screen indicating start of copying by the copy application 141 by using the standard function service 170. Also, the expansion application can cause the printer application 142 to print various pieces of job data, a file, and the like acquired by the expansion application itself or designated via the operation unit 11 by using the standard function service 170. Also, the expansion application can acquire image data designated via the operation unit 11 among facsimile image data received by the fax application 143, or cause the fax application 143 to transmit a file or the like designated via the operation unit 11 by using the standard function service 170.

The control unit 30 achieves, by executing the expansion service program (see FIG. 1), an expansion service, which is a service that provides a function other than a standard function of the image forming apparatus 10. For example, the control unit 30 achieves an expansion function service 181, which is an expansion service that provides an expansion application with a service in which the platform service IF unit 130 is used without using a standard application, or the general-purpose OS 110 is used by using the general-purpose OS service infrastructure 150; and a backend service 182, which is an expansion service that provides an expansion application with a service in which the general-purpose OS 110 is used by using the general-purpose OS service infrastructure 150 without using the platform service IF unit 130. The expansion function service 181 uses the platform service IF unit 130 via the expansion application service IF unit 160. The control unit 30 can achieve at least one expansion function service, in addition to the expansion function service 181. The control unit 30 can achieve at least one backend service, in addition to the backend service 182.

The expansion function service is a service that provides an expansion application with a function of expanding a standard function of the image forming apparatus 10.

The backend service is a service that operates on a backend. The backend service is a service that provides a function other than a function of expanding a standard function of the image forming apparatus 10 among functions of the image forming apparatus 10 other than the standard function. The backend service includes, for example, a service that provide a function of monitoring the image forming apparatus 10; a service that provides a function of monitoring the entirety of a system constituted of a plurality of image forming apparatuses; a service that provides a function of monitoring a specific server; a service that provides a function of collecting, from the image forming apparatus 10, information such as a counter indicating the number of copies printed by the image forming apparatus 10, and converting the collected information into information in a format comprehensible to a person; and a service that provides a function of converting a format of information to be output from the image forming apparatus 10 from a format of an old interface to a format of a new interface.

The control unit 30 achieves, by executing the expansion program 20c, an expansion service management unit 190 that performs management of an expansion service, such as activation, start, and stop of an expansion service. The expansion service management unit 190 monitors a status of the expansion service and the general-purpose OS service infrastructure 150.

The control unit 30 achieves, by executing the expansion program 20c, an expansion application management unit 200 that performs management of an expansion application, such as activation, start, and stop of an expansion application.

The control unit 30 achieves an expansion application 210 by executing the expansion application program 20d (see FIG. 1). Note that, the control unit 30 can also achieve at least one expansion application, in addition to the expansion application 210. The expansion application is an application directly used by the user, and includes a user interface. The user can use a function provided by the expansion application by operating the user interface of the expansion application. For example, the expansion application may be a practical application such as optical character recognition (OCR), a surveillance camera application, watermark creation, invoice creation, employee list management, slip management, contract management, business card management, PDF creation, ledger management, group management, and the like; or may be an installer application that makes addition or change of a device driver, a firmware, and the like on the general-purpose OS 110; or may be other management applications. The expansion application can use the general-purpose OS 110 by invoking the standard function service 170 and using a standard application, use the general-purpose OS 110 by invoking an expansion service without using a standard application, or use the general-purpose OS 110 by directly invoking the general-purpose OS service infrastructure 150.

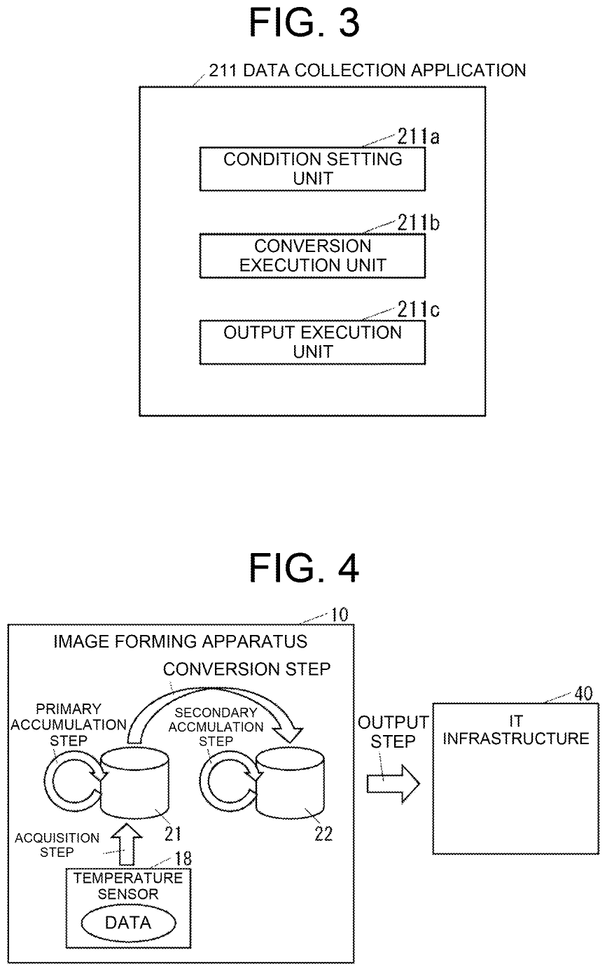

FIG. 3 is a diagram illustrating a data collection application 211, which is an expansion application.

The control unit 30 achieves, by executing an expansion application program, the data collection application 211, which is an expansion application that performs an operation related to a data collection function, as illustrated in FIG. 3. The data collection application 211 is an expansion application that uses the data collection service 124, and constitutes a service use unit according to the present invention. The data collection application 211 includes a condition setting unit 211a that sets a condition (hereinafter, referred to as a “data collection condition”) of collecting data in a data collection function with respect to the data collection service 124, a conversion execution unit 211b that executes a conversion step to be described later, and an output execution unit 211c that executes an output step to be described later. Settings in the condition setting unit 211a include registration of a data collection condition, and deletion of a data collection condition.

FIG. 4 is a diagram illustrating a model of a flow of processing when a data collection function is achieved by the image forming apparatus 10.

As illustrated in FIG. 4, the data collection function is a function of transmitting internal data of the image forming apparatus 10 to an information technology (IT) infrastructure 40 outside of the image forming apparatus 10. Herein, internal data of the image forming apparatus 10 include data on detection values by various sensors such as, for example, the temperature sensor 18 and the humidity sensor 19, data on values of a counter indicating the number of copies by the image forming apparatus 10, and data indicating the number of errors in the image forming apparatus 10. In FIG. 4, the temperature sensor 18 is illustrated as a representative. Also, the IT infrastructure 40 is, for example, a personal computer (PC) of an individual, a server that performs analysis of data, and the like.

The data collection function includes: an acquisition step of acquiring data, a primary accumulation step of accumulating and managing, in an area (hereinafter, referred to as an “internal processing area”) 21 for internal processing data in the storage unit 20, data (hereinafter, referred to as “internal processing data”) for processing inside the image forming apparatus 10; a conversion step of converting internal processing data accumulated in the internal processing area 21 into data (hereinafter, referred to as “external output data”) for outputting to the outside of the image forming apparatus 10; a secondary accumulation step of accumulating and managing, in an area (hereinafter, referred to as an “external output area”) 22 for external output data in the storage unit 20, external processing data generated by the conversion step; and an output step of outputting, to the IT infrastructure 40 outside of the image forming apparatus 10, external output data accumulated in the external output area 22.

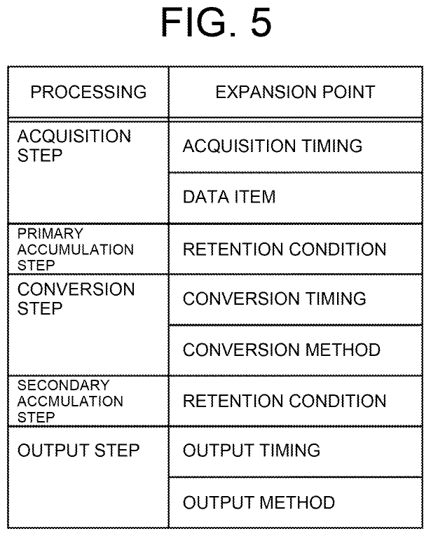

FIG. 5 is a diagram illustrating an expandable point (hereinafter, referred to as an “expansion point”) in data collection processing by the image forming apparatus 10.

As illustrated in FIG. 5, data collection processing includes, as an expansion point in the acquisition step, an acquisition timing indicating a timing at which data are acquired, and a data item indicating an item of data to be acquired. Examples of the acquisition timing include a “print start time” and a “print finish time”. Examples of the data item include an “apparatus internal temperature”, an “apparatus internal humidity”, and a “counter”.

The data collection processing includes, as an expansion point in the primary accumulation step, a retention condition, which is a condition for retaining internal processing data in the internal processing area 21. Examples of the retention condition include “until a time when conversion into external output data is completed”.

The data collection processing includes, as an expansion point in the conversion step, a conversion timing indicating a timing at which internal processing data are converted into external output data, and a conversion method indicating a data format of external output data after conversion. Examples of the conversion timing includes “12:00 every day” and “12:00 every day except Saturday and Sunday”. Examples of the conversion method include a “comma-separated values (CSV) file format” and a “JavaScript object notation (JSON) format”.

The data collection processing includes, as an expansion point in the secondary accumulation step, a retention condition, which is a condition for retaining external output data in the external output area 22. Examples of the retention condition include “until a time when output to the outside of the image forming apparatus 10 is completed”.

The data collection processing includes, as an expansion point in the output step, an output timing indicating a timing at which external output data are output to the outside of the image forming apparatus 10, and an output method indicating a method of outputting external output data to the outside of the image forming apparatus 10. Examples of the output timing include “12:00 every day” and “12:00 every day except Saturday and Sunday”. Examples of the output method include “transmit to a specific destination by mail” and “transmit to a specific server by hypertext transfer protocol (HTTP) format”.

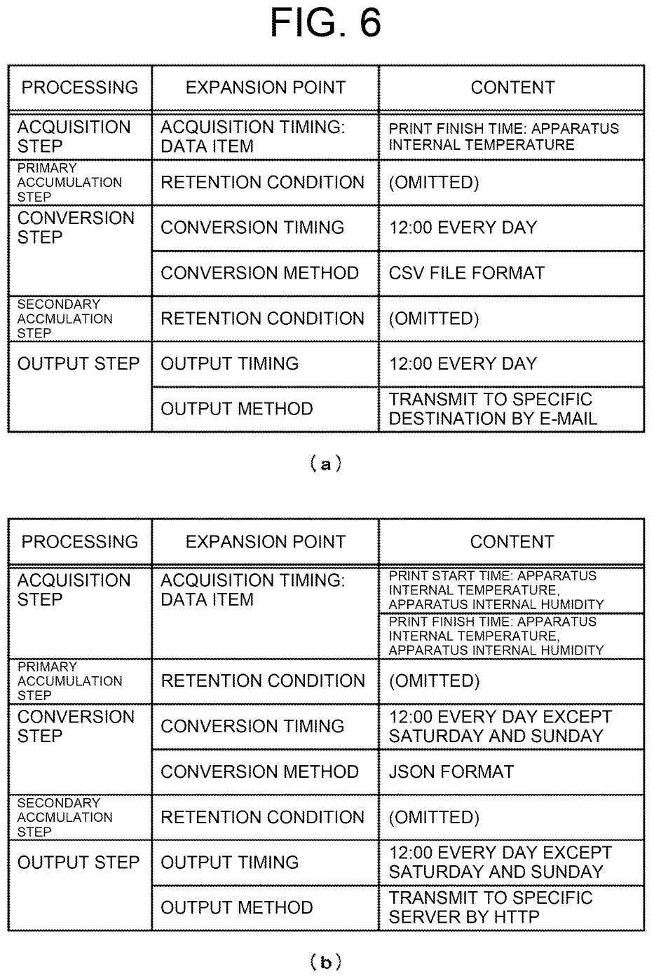

FIG. 6(a) is a diagram illustrating an example of a standard specification of the data collection function. FIG. 6(b) is a diagram illustrating an example of an expanded specification of the data collection function.

The data collection function according to the specification illustrated in FIG. 6(a) is a standard function indicating “an apparatus internal temperature at a print finish time is transmitted to a specific destination by mail by the CSV file format at 12:00 every day”. The data collection function according to the specification illustrated in FIG. 6(b) is an expanded function indicating “an apparatus internal temperature and an apparatus internal humidity at a print start time and a print finish time are transmitted to a specific server by the HTTP format at 12:00 every day except Saturday and Sunday by the JSON format”. The specification of the data collection function is settable by the data collection condition.

When the specification illustrated in FIG. 6(a) is changed to the specification illustrated in FIG. 6(b), the “acquisition timing”, the “data item”, the “conversion timing”, and the “output timing” among expansion points can be changed by settings of the data collection condition by the condition setting unit 211a. Specifically, the condition setting unit 211a can change the “acquisition timing”, the “data item”, the “conversion timing”, and the “output timing” in the data collection function by registering, in the data collection service 124, a data collection condition indicating the “acquisition timing”, the “data item”, the “conversion timing”, and the “output timing” in response to an instruction from the outside of the image forming apparatus 10.

Next, an operation of the image forming apparatus 10 in a case where data collection processing is performed is described.

First, an operation of the image forming apparatus 10 in a case where the acquisition step and the primary accumulation step are performed is described.

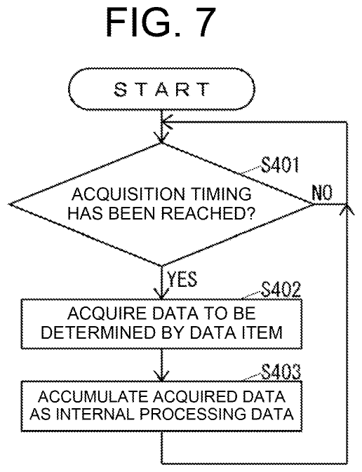

FIG. 7 is a flowchart of an operation of the image forming apparatus 10 in a case where the acquisition step and the primary accumulation step are performed.

As illustrated in FIG. 7, the data collection service 124 determines whether the “acquisition timing” has been reached until it is determined that the “acquisition timing” in the specification of the data collection function has been reached (S401).

When the data collection service 124 determines that the “acquisition timing” in the specification of the data collection function has been reached in S401, the data collection service 124 acquires data to be determined by the “data item” in the specification of the data collection function (S402).

After processing in S402, the data collection service 124 accumulates, in the internal processing area 21, the data acquired in S402, as internal processing data (S403).

After processing in S403, the data collection service 124 performs processing in S401.

Note that, pieces of processing in S401 and S402 correspond to the acquisition step, and processing in S403 corresponds to the primary accumulation step.

Next, an operation of the image forming apparatus 10 in a case where the conversion step and the secondary accumulation step are performed is described.

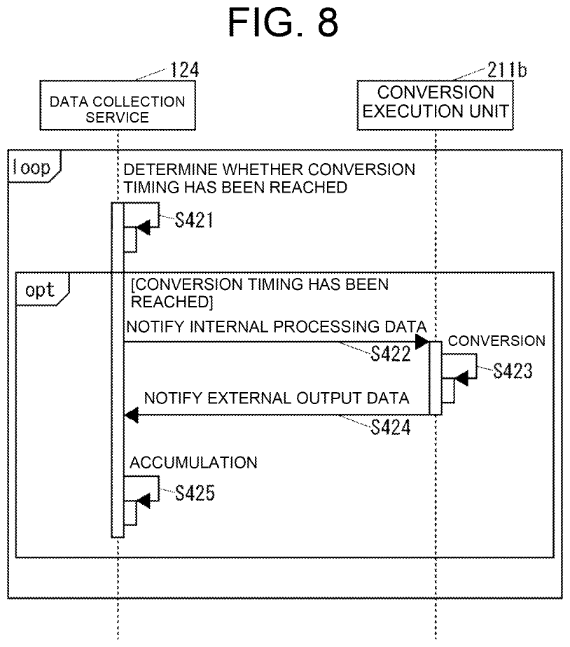

FIG. 8 is a sequence diagram of an operation of the image forming apparatus 10 in a case where the conversion step and the secondary accumulation step are performed.

As illustrated in FIG. 8, the data collection service 124 determines whether the “conversion timing” in the specification of the data collection function has been reached (S421).

When the data collection service 124 determines that the “conversion timing” in the specification of the data collection function has been reached in S421, the data collection service 124 notifies the conversion execution unit 211b of data to be determined by the “data item” in the specification of the data collection function among internal processing data accumulated in the internal processing area 21 (S422). Herein, a destination of which the data collection service 124 notifies the conversion execution unit 211b is, for example, registered in the data collection service 124 by the conversion execution unit 211b at the time of startup of the image forming apparatus 10.

When the conversion execution unit 211b is notified of the internal processing data in S422, the conversion execution unit 211b converts the internal processing data notified in S422 into external output data by the “conversion method” in the specification of the data collection function (S423).

After processing in S423, the conversion execution unit 211b notifies the data collection service 124 of the external output data generated in S423 (S424).

When the data collection service 124 is notified of the external output data in S424, the data collection service 124 accumulates, in the external output area 22, the external output data notified in S424 (S425).

The control unit 30 repeats processing from S421 to S425.

Note that, pieces of processing from S421 to S424 correspond to the conversion step, and processing in S425 corresponds to the secondary accumulation step.

In FIG. 8, in S424, the conversion execution unit 211b notifies the data collection service 124 of the external output data generated in S423 all at once. Alternatively, the conversion execution unit 211b may notify the data collection service 124 of the external output data several times in a divided manner. In a case where the conversion execution unit 211b notifies the data collection service 124 of the external output data several times in a divided manner, the data collection service 124 may be notified that notification of all pieces of external output data is completed when notification of all the pieces of external output data generated in S423 is completed. Then, in a case where completion of notification of all the pieces of external output data is notified, the data collection service 124 may complete the secondary accumulation step.

Next, an operation of the image forming apparatus 10 in a case where the output step is performed is described.

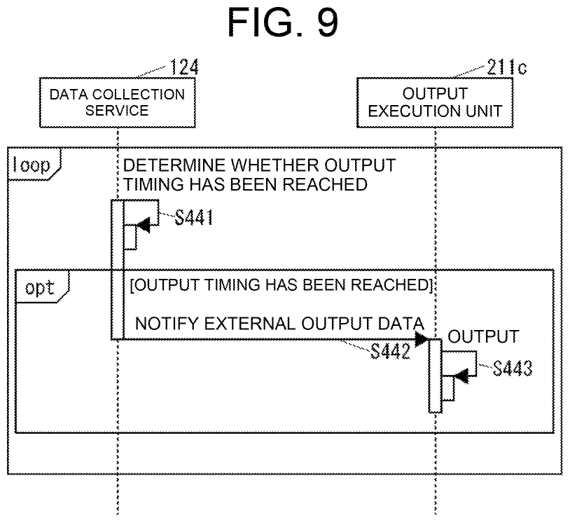

FIG. 9 is a sequence diagram of an operation of the image forming apparatus 10 in a case where the output step is performed.

As illustrated in FIG. 9, the data collection service 124 determines whether the “output timing” in the specification of the data collection function has been reached (S441).

When the data collection service 124 determines that the “output timing” in the specification of the data collection function has been reached in S441, the data collection service 124 notifies the output execution unit 211c of data to be determined by the “data item” in the specification of the data collection function among external output data accumulated in the external output area 22 (S442). Herein, a destination of which the data collection service 124 notifies the output execution unit 211c is, for example, registered in the data collection service 124 by the output execution unit 211c at the time of startup of the image forming apparatus 10.

When the output execution unit 211c is notified of the external output data in S442, the output execution unit 211c outputs the external output data notified in S442 by the “output method” in the specification of the data collection function (S443).

The control unit 30 repeats processing from S441 to S443.

Note that, in a case where the data collection service 124 simultaneously performs data collection processing in each of a plurality of data collection conditions, the data collection service 124 distinguishes internal processing data, external output data, a conversion execution unit, and an output execution unit for each data collection condition by assigning an ID, which is identification information, to the internal processing data, the external output data, the conversion execution unit, and the output execution unit, for each data collection condition.

Next, an operation of the image forming apparatus 10 when the data collection condition is updated during execution of data collection processing is described.

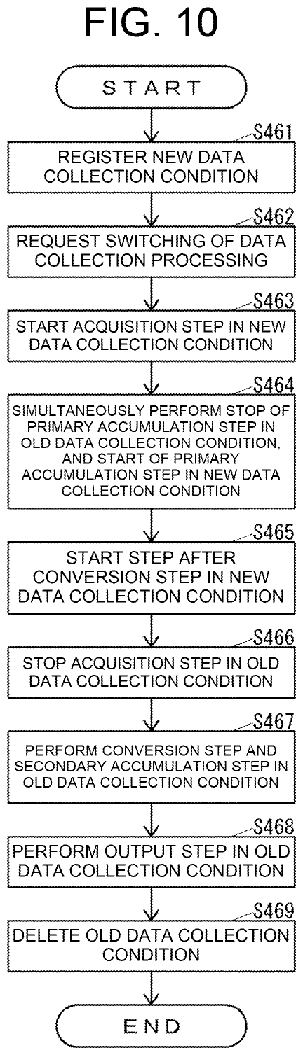

FIG. 10 is a flowchart of an operation of the image forming apparatus 10 when the data collection condition is updated during execution of data collection processing.

In a case where data collection processing is executed, the control unit 30 performs the operation illustrated in FIG. 10 when an instruction to update the data collection condition of data collection processing is given via, for example, the operation unit 11 or the network communication unit 16.

As illustrated in FIG. 10, the condition setting unit 211a registers, in the data collection service 124, a new data collection condition (hereinafter, referred to as a “new data collection condition”), which becomes a data collection condition after updating (S461).

Subsequently, the condition setting unit 211a requests the data collection service 124 to switch the currently executed data collection processing from data collection processing in a data collection condition before updating (hereinafter, referred to as an “old data collection condition) to data collection processing in the new data collection condition (S462).

Upon receiving the request in S462, the data collection service 124 starts an acquisition step of data collection processing in the new data collection condition (S463). Herein, the data collection service 124 does not start a primary accumulation step of data collection processing in the new data collection condition. Also, the data collection service 124 continues to perform data collection processing in the old data collection condition.

After processing in S463, the data collection service 124 simultaneously performs stop of the primary accumulation step of data collection processing in the old data collection condition, and start of the primary accumulation step of data collection processing in the new data collection condition (S464).

After processing in S464, the data collection service 124 performs start of a step after the conversion step of data collection processing in the new data collection condition (S465). Specifically, the data collection service 124 starts a conversion step, a secondary accumulation step, and an output step with respect to data collection processing in the new data collection condition.

After processing in S465, the data collection service 124 stops the acquisition step of data collection processing in the old data collection condition (S466).

After processing in S466, in a case where the “conversion timing” in the old data collection condition has been reached, the data collection service 124 performs the conversion step and the secondary accumulation step of data collection processing in the old data collection condition similarly to the processing from S422 to S425 (see FIG. 8) (S467). Therefore, all pieces of data that have not yet been converted into external output data among internal processing data accumulated in the internal processing area 21 in the primary accumulation step of data collection processing in the old data collection condition are converted into external output data, and the external output data are accumulated in the external output area 22.

After processing in S467, in a case where the “output timing” in the old data collection condition has been reached, the data collection service 124 performs the output step of data collection processing in the old data collection condition similarly to the processing from S442 to S443 (see FIG. 9) (S468). Therefore, all pieces of data that have not yet been output to the outside of the image forming apparatus 10 among external output data accumulated in the external output area 22 in the secondary accumulation step of data collection processing in the old data collection condition are output to the outside of the image forming apparatus 10.

After processing in S468, the data collection service 124 deletes the old data collection condition (S469), and terminates the operation illustrated in FIG. 10.

In the operation illustrated in FIG. 10, the image forming apparatus 10 simultaneously performs stop of the primary accumulation step of data collection processing in the old data collection condition, and start of the primary accumulation step of data collection processing in the new data collection condition. Therefore, it is possible to suppress occurrence of missing or overlapping of data during an acquisition period when the data collection condition is switched between internal processing data accumulated in the internal processing area 21 in the primary accumulation step of data collection processing in the old data collection condition, and internal processing data accumulated in the internal processing area 21 in the primary accumulation step of data collection processing in the new data collection condition. Therefore, the image forming apparatus 10 can output appropriate data during all periods to the outside, even when the data collection condition is updated during execution of data collection processing.

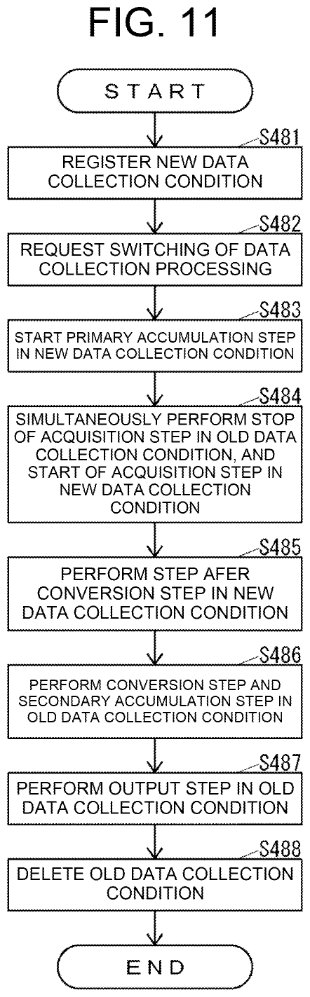

In the operation illustrated in FIG. 10, the image forming apparatus 10 updates the data collection condition during execution of data collection processing by simultaneously performing stop of the primary accumulation step of data collection processing in the old data collection condition, and start of the primary accumulation step of data collection processing in the new data collection condition. Alternatively, as illustrated in FIG. 11, the image forming apparatus 10 may update the data collection condition during execution of data collection processing by simultaneously performing stop of the acquisition step of data collection processing in the old data collection condition, and start of the acquisition step of data collection processing in the new data collection condition.

FIG. 11 is a flowchart of an operation of the image forming apparatus 10, which is different from the example illustrated in FIG. 10, when the data collection condition is updated during execution of data collection processing.

In a case where data collection processing is executed, the control unit 30 performs the operation illustrated in FIG. 11 when an instruction to update the data collection condition of the data collection processing is given via, for example, the operation unit 11 or the network communication unit 16.

As illustrated in FIG. 11, the condition setting unit 211a performs processing from S481 to S482 similarly to the processing from S461 to S462 (see FIG. 10).

Upon receiving the request in S482, the data collection service 124 starts the primary accumulation step of data collection processing in the new data collection condition (S483).

After processing in S483, the data collection service 124 simultaneously performs stop of the acquisition step of data collection processing in the old data collection condition, and start of the acquisition step of data collection processing in the new data collection condition (S484).

After processing in S484, the data collection service 124 starts a step after the conversion step of data collection processing in the new data collection condition (S485). Specifically, the data collection service 124 starts a conversion step, a secondary accumulation step, and an output step with respect to data collection processing in the new data collection condition.

After processing in S485, the data collection service 124 performs processing from S486 to S488 similarly to the processing from S467 to S469 (see FIG. 10), and terminates the operation illustrated in FIG. 11.

In the operation illustrated in FIG. 11, the image forming apparatus 10 simultaneously performs stop of the acquisition step of data collection processing in the old data collection condition, and start of the acquisition step of data collection processing in the new data collection condition. Therefore, it is possible to suppress occurrence of missing or overlapping of data during an acquisition period when the data collection condition is switched between internal processing data accumulated in the internal processing area 21 in the primary accumulation step of data collection processing in the old data collection condition, and internal processing data accumulated in the internal processing area 21 in the primary accumulation step of data collection processing in the new data collection condition. Therefore, the image forming apparatus 10 can output appropriate data during all periods to the outside, even when the data collection condition is updated during execution of data collection processing.

In the operation illustrated in FIG. 11, an acquisition step of data collection processing in the old data collection condition, and an acquisition step of data collection processing in the new data collection condition are not performed at the same time. Therefore, as compared with the operation illustrated in FIG. 10, load on the system of the image forming apparatus 10 can be reduced.

The primary accumulation step is performed only for the storage unit 20 in data collection processing in the old data collection condition and data collection processing in the new data collection condition. On the other hand, data acquisition may be performed at different locations in the system of the image forming apparatus 10 in data collection processing in the old data collection condition and data collection processing in the new data collection condition. In a case where data acquisition is performed at different locations in the system of the image forming apparatus 10 in data collection processing in the old data collection condition and data collection processing in the new data collection condition, it is difficult to simultaneously perform stop of the acquisition step of data collection processing in the old data collection condition and start of the acquisition step of data collection processing in the new data collection condition, as compared with a case where stop of the primary accumulation step of data collection processing in the old data collection condition and start of the primary accumulation step of data collection processing in the new data collection condition are simultaneously performed. Specifically, in a case where data acquisition is performed at different locations in the system of the image forming apparatus 10 in data collection processing in the old data collection condition and data collection processing in the new data collection condition, it is easy to achieve the operation illustrated in FIG. 10, as compared with the operation illustrated in FIG. 11.

Next, an operation of the image forming apparatus 10 in a case where internal processing data are deleted from the internal processing area 21 is described.

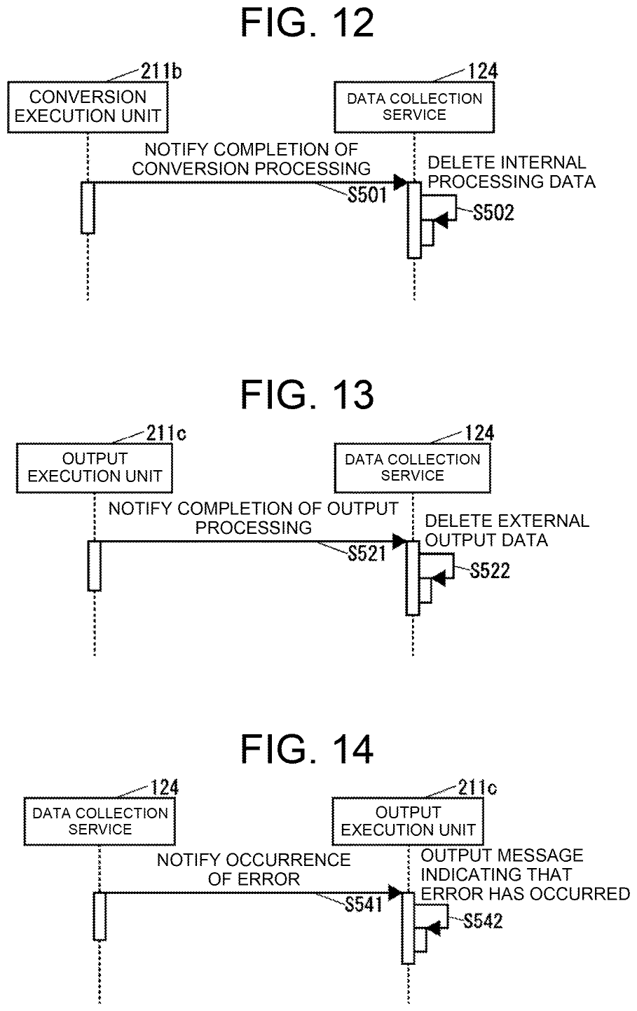

FIG. 12 is a sequence diagram of an operation of the image forming apparatus 10 in a case where internal processing data are deleted from the internal processing area 21.

When conversion processing in S423 is completed, the conversion execution unit 211b notifies the data collection service 124 of completion of the conversion processing, as illustrated in FIG. 12 (S501).

Upon receiving the notification in S501, in a case where the retention condition of the primary accumulation step indicates “until a time when conversion into external output data is completed”, the data collection service 124 deletes, from the internal processing area 21, internal processing data to be notified in S501 (S502).

Next, an operation of the image forming apparatus 10 in a case where external output data are deleted from the external output area 22 is described.

FIG. 13 is a sequence diagram of the operation of the image forming apparatus 10 in a case where external output data are deleted from the external output area 22.

When output processing in S443 is completed, the output execution unit 211c notifies the data collection service 124 of completion of the output processing, as illustrated in FIG. 13 (S521).

Upon receiving the notification in S521, in a case where the retention condition of the secondary accumulation step indicates “until a time when output to the outside of the image forming apparatus 10 is completed”, the data collection service 124 deletes, from the external output area 22, external output data to be notified in S521 (S522).

Next, an operation of the image forming apparatus 10 in a case where an error related to data collection processing has occurred is described.

In a case where an error related to data collection processing has occurred in the data collection service 124 itself, the data collection service 124 can recognize the occurrence of the error. In a case where an error related to data collection processing has occurred in the conversion execution unit, the data collection service 124 can recognize the occurrence of the error, based on a notification from the conversion execution unit. In a case where an error related to data collection processing has occurred in the output execution unit, the data collection service 124 can recognize the occurrence of the error, based on a notification from the output execution unit.

FIG. 14 is a sequence diagram of an operation of the image forming apparatus 10 in a case where an error related to data collection processing has occurred.

When the data collection service 124 recognizes occurrence of an error related to data collection processing, as illustrated in FIG. 14, the data collection service 124 notifies the output execution unit 211c of the occurrence of the error related to data collection processing (S541).

Upon receiving the notification in S541, the output execution unit 211c outputs, to an output destination set for the output step of data collection processing in which the error has occurred, a message indicating that the error has occurred (S542). Therefore, in the output destination, it is possible to recognize that data output processing is not performed in an ordinary manner due to occurrence of the error.

Note that, processing illustrated in FIG. 14 is an example. In a case where the data collection service 124 recognizes occurrence of an error related to data collection processing, the data collection service 124 notifies a notification destination that is registered in advance, of the occurrence of the error related to data collection processing. Then, in a case where the notification destination is notified of the occurrence of the error related to data collection processing, the data collection service 124 performs processing for the error, which is set in advance. This configuration allows the image forming apparatus 10 to reduce an impact in a case where an error has occurred.

As described above, the image forming apparatus 10 sets, in the data collection service 124, a parameter related to the data collection function, specifically, an acquisition timing, a data item, a retention condition, a conversion timing, and an output timing by means of the data collection application 211, and performs specific processing in the data collection function by means of the data collection service 124 according to the parameter set by the data collection application 211 (S401 to S403, S421 to S422, S425, S441 to S442, S502, and S522). Therefore, it is possible to expand the data collection function without updating the data collection service 124, and consequently, expansion of the data collection function can be facilitated.

The image forming apparatus 10 performs specific processing in the data collection function by means of the data collection application 211 in response to a notification from the data collection service 124 (S423 to S424, and S443). Therefore, it is possible to expand the data collection function without updating the data collection service 124, and consequently, expansion of the data collection function can be facilitated.

The image forming apparatus 10 can perform expansion for conversion (S423) of collected data. In the image forming apparatus 10 according to the present embodiment, the conversion execution unit 211b performs conversion (S423) from internal processing data into external output data. Alternatively, in a case where conversion from internal processing data into external output data can be expanded by changing a parameter, the conversion may be achieved by the data collection service 124.

The image forming apparatus 10 can perform expansion for output (S443) of data to the outside of the image forming apparatus 10. In the image forming apparatus 10 according to the present embodiment, the output execution unit 211c performs output (S443) of external output data. Alternatively, in a case where output of external output data can be expanded by changing a parameter, the output may be achieved by the data collection service 124.

In the image forming apparatus 10, the data collection service 124 is achieved by the firmware 20b of the image forming apparatus 10, and the data collection application 211 is achieved by an expansion application program, which is a program other than the firmware 20b. Therefore, it is possible to expand the data collection function without updating the firmware 20b, and consequently, expansion of the data collection function can be facilitated.

In the present embodiment, settings of a data collection condition, a conversion step, and an output step are achieved by an expansion application. Alternatively, at least one of data collection condition settings, a conversion step, and an output step may be achieved by a configuration other than the expansion application. Specifically, the service use unit according to the present invention may be achieved by a configuration other than the expansion application. For example, data collection condition settings, a conversion step, and an output step may be achieved by either one of the standard application, the expansion function service, and the backend service. Note that, since the standard application is achieved by the firmware 20b, in a case of expansion, it is necessary to change the firmware 20b.

Some of the plurality of programs according to the present embodiment may be configured as one program. For example, the firmware 20b and the expansion application program may be configured as one program.

In the present embodiment, an electronic device according to the present invention is an image forming apparatus. Alternatively, the electronic device may be an electronic device other than an image forming apparatus such as, for example, a personal computer (PC).

### DESCRIPTION OF REFERENCE NUMERALS

10 Image forming apparatus (electronic device)
20b Firmware (program)
20d Expansion application program (program)
20c Expansion program (program)
124 Data collection service
211 Data collection application (service use unit)

1. An electronic device comprising:
a data collection service that provides a service related to a function of collecting data; and
a service use unit that uses the data collection service, wherein
the service use unit sets a parameter related to the function in the data collection service, setting of the parameter including registration, deletion, and modification of the parameter, and
the data collection service performs specific processing in the function according to the parameter set by the service use unit.

2. An electronic device comprising:
a data collection service that provides a service related to a function of collecting data; and
a service use unit that uses the data collection service, wherein
the service use unit performs specific processing in the function in response to a notification based on a data collection condition from the data collection service.

3. The electronic device according to claim 1, wherein
the data collection service is achieved by a firmware of the electronic device, and
the service use unit is achieved by a program other than the firmware.

4. The electronic device according to claim 1, wherein
the specific processing includes conversion of the data.

5. The electronic device according to claim 1, wherein
the specific processing includes outputting the data to an outside of the electronic device.

6. A computer-readable non-transitory recording medium having stored thereon a program causing an electronic device to achieve:
a data collection service that provides a service related to a function of collecting data; and
a service use unit that uses the data collection service, wherein
the service use unit sets a parameter related to the function in the data collection service, setting of the parameter including registration, deletion, and modification of the parameter, and
the data collection service performs specific processing in the function according to the parameter set by the service use unit.

7. A computer-readable non-transitory recording medium having stored thereon a program causing an electronic device to achieve:
a data collection service that provides a service related to a function of collecting data; and
a service use unit that uses the data collection service, wherein
the service use unit performs specific processing in the function in response to a notification based on a data collection condition from the data collection service.
